(19) United States
(12) Patent Application Publication
(10) Pub. No.: US 2025/0039813 A1
(43) Pub. Date: Jan. 30, 2025

(54) UE INITATIED EARLY TIMING ADVANCE ACQUISITION

(71) Applicant: Samsung Electronics Co., Ltd., Suwon-si (KR)

(72) Inventors: Shiyang Leng, Allen, TX (US); Anil Agiwal, McKinney, TX (US)

(21) Appl. No.: 18/769,270

(22) Filed: Jul. 10, 2024

Related U.S. Application Data
(60) Provisional application No. 63/528,575, filed on Jul. 24, 2023.

(51) Int. Cl. H04W 56/00; H04W 36/36; H04W 74/0833

(52) U.S. Cl. CPC H04W 56/0045; H04W 36/362; H04W 74/0833

(57) ABSTRACT

Methods and apparatuses for user equipment (UE) initiated early timing advance acquisition A UE includes a transceiver configured to receive an early timing advance (TA) configuration including an early TA random access (RA) resource for a candidate cell for conditional layer 1/layer 2 triggered mobility (CLTM), transmit, on the early TA RA resource, a physical random access channel (PRACH) preamble to the candidate cell, and receive a message including a current TA for the candidate cell. The UE further includes a processor operatively coupled to the transceiver. The processor is configured to apply the current TA to the candidate cell, and start a time alignment timer (TAT) for the candidate cell.

### CROSS-REFERENCE TO RELATED APPLICATION(S) AND CLAIM OF PRIORITY

This application claims priority under 35 U.S.C. § 119 (e) to U.S. Provisional Patent Application No. 63/528,575 filed on Jul. 24, 2023. The above-identified provisional patent application is hereby incorporated by reference in its entirety.

### TECHNICAL FIELD

This disclosure relates generally to wireless networks. More specifically, this disclosure relates to UE initiated early timing advance acquisition.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for UE initiated early timing advance acquisition.

In one embodiment, a user equipment (UE) is provided. The UE includes a transceiver. The transceiver is configured to receive an early timing advance (TA) configuration including an early TA random access (RA) resource for a candidate cell for conditional layer 1/layer 2 triggered mobility (CLTM), transmit, on the early TA RA resource, a physical random access channel (PRACH) preamble to the candidate cell, and receive a message including a current TA for the candidate cell. The UE further includes a processor operatively coupled to the transceiver. The processor is configured to apply the current TA to the candidate cell, and start a time alignment timer (TAT) for the candidate cell.

In another embodiment, a base station (BS) is provided. The BS includes a processor and a transceiver operatively coupled to the processor. The transceiver is configured to transmit an early TA configuration including an early TA RA resource for a candidate cell for CLTM, receive, on an early TA RA resource, a PRACH preamble for the candidate cell, and transmit a message including a current TA for the candidate cell.

In yet another embodiment, a method of operating a UE is provided. The method includes receiving an early TA configuration including an early TA RA resource for a candidate cell for CLTM, and transmitting, on the early TA RA resource, a PRACH preamble to the candidate cell. The method further includes receiving a message including a current TA for the candidate cell, applying the current TA to the candidate cell, and starting a TAT for the candidate cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example conditional handover operation according to embodiments of the present disclosure;

FIG. 5 illustrates an example UE procedure of UE initiated early TA acquisition for a non-serving cell according to embodiments of the present disclosure;

FIG. 6 illustrates an example UE procedure to perform 4-step CBRA for early TA acquisition without serving cell involvement according to embodiments of the present disclosure;

FIG. 7 illustrates an example Early TA Contention Resolution Identity MAC CE according to embodiments of the present disclosure;

FIG. 8 illustrates an example UE procedure to perform 4-step CBRA for early TA acquisition with serving cell involvement according to embodiments of the present disclosure;

FIG. 9 illustrates an example UE procedure to perform 2-step CBRA for early TA acquisition without serving cell involvement according to embodiments of the present disclosure; and

FIG. 10 illustrates an example method for UE initiated early timing advance acquisition according to embodiments of the present disclosure.

### DETAILED DESCRIPTION

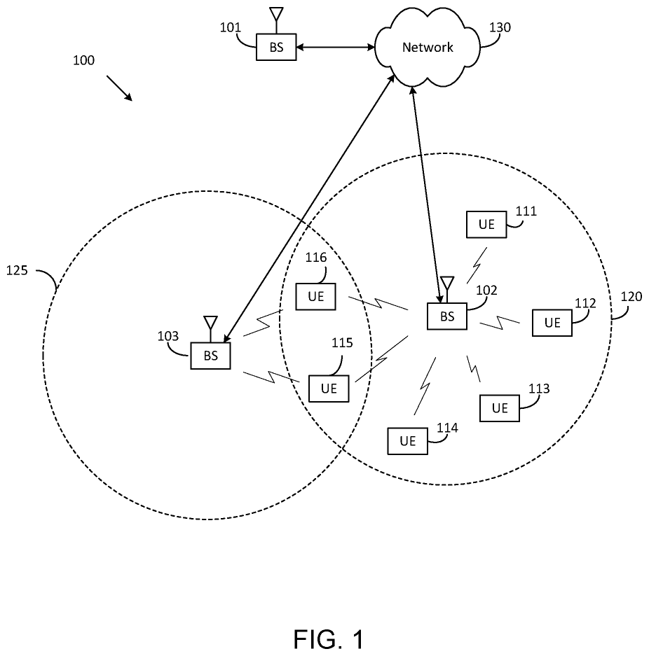

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE initiated early timing advance acquisition. In certain embodiments, one or more of the gNBs 101-103 includes circuitry, programing, or a combination thereof, to support UE initiated early timing advance acquisition in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

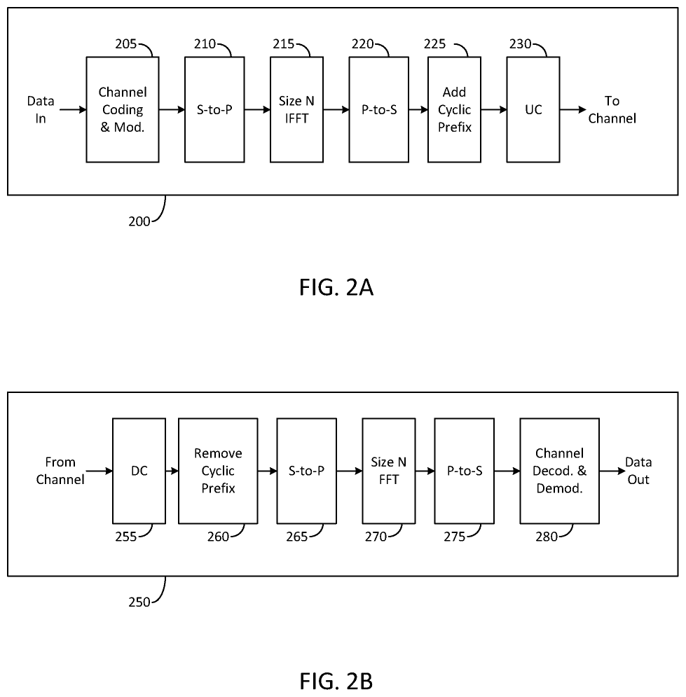

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support UE initiated early timing advance acquisition as described in embodiments of the present disclosure.

The transmit path 200 includes a channel coding and modulation block 205, a serial to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

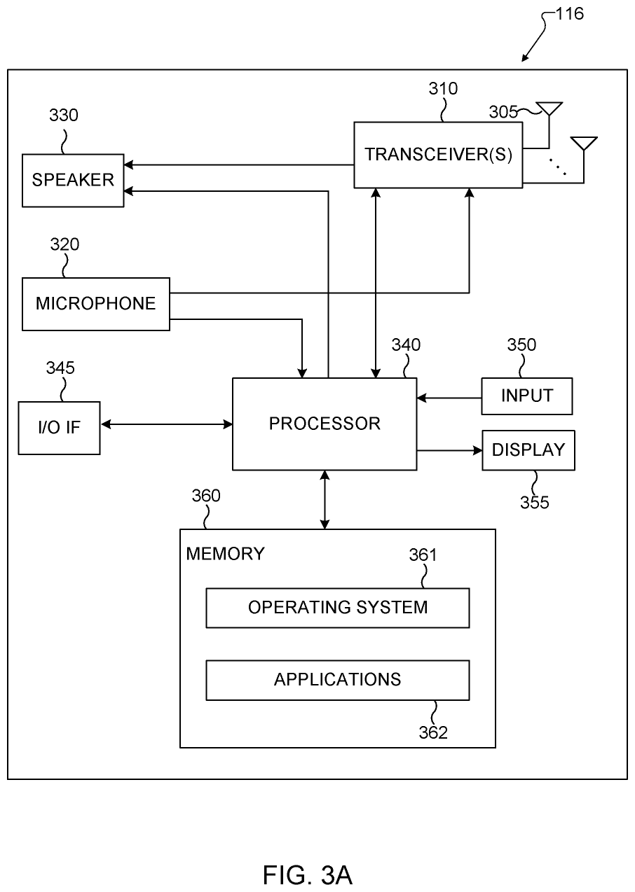

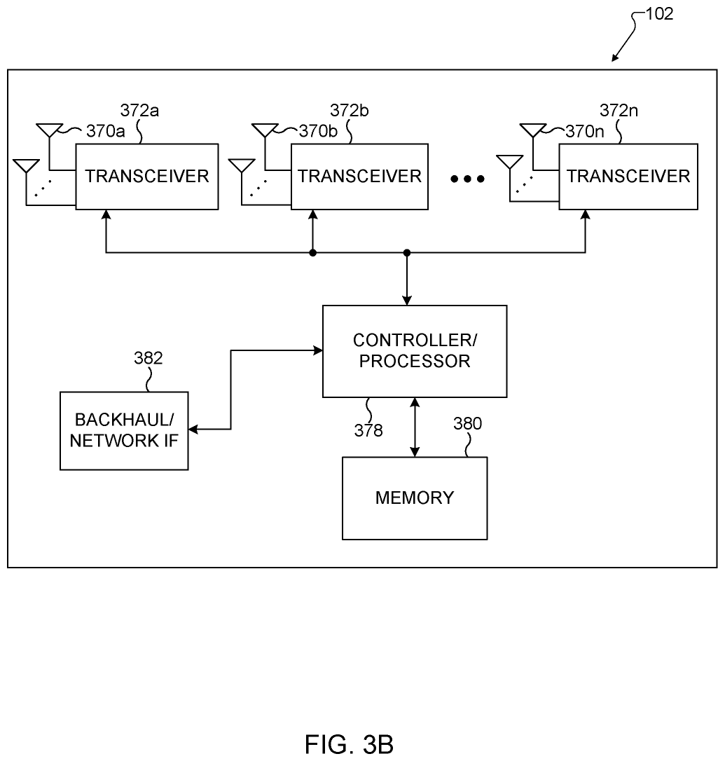

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE initiated early timing advance acquisition as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support UE initiated early timing advance acquisition as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

3GPP (Third-Generation Partnership Project) has developed technical specifications and standards to define the new 5G radio-access technology, known as 5G NR (New Radio). Mobility handling is a critical aspect in any mobile communication system including 5G system. For a UE (User Equipment) in connected mode, mobility is controlled by the network with the assistance from the UE to maintain a good quality of connection. Based on the measurement on radio link quality of the serving cell and neighboring cell(s) reported by the UE, the network may hand over the UE to a neighboring cell that can provide better radio conditions when the UE is experiencing a degraded connection to the serving cell. In release-15 NR, the basic mechanism and procedure of network-controlled mobility in connected mode is developed. In release-16 NR, enhancements to network-controlled mobility in connected mode are introduced to mitigate connection interruption during handover procedure. Specifically, two enhanced handover mechanisms are developed, known as conditional handover (CHO) and dual active protocol stack (DAPS).

In a CHO procedure, upon receiving a CHO configuration in a radio resource control (RRC) reconfiguration message which contains configuration for multiple candidate cells, a UE starts evaluating the CHO execution conditions for the candidate cell(s). If at least one CHO candidate cell satisfies the corresponding CHO execution condition, the UE detaches from the source cell, applies the configuration and synchronizes to the target cell and completes the CHO procedure by sending a RRC reconfiguration complete message to the target cell. The UE releases stored CHO configurations after successful completion of the handover procedure.

More specifically, a CHO is defined as a handover that is executed by the UE when one or more handover execution conditions are met. The UE starts evaluating the execution condition(s) upon receiving the CHO configuration and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may comprise one or two trigger condition(s). Only a single reference signal (RS) type is supported and at most two different trigger quantities (e.g., RSRP and RSRQ, RSRP and SINR, etc.) can be configured simultaneously for the evaluation of CHO execution condition of a single candidate cell.
Before any CHO execution condition is satisfied, upon reception of a handover (HO) command (without CHO configuration), the UE executes the HO procedure regardless of any previously received CHO configuration.
While executing CHO, i.e., from the time when the UE starts synchronization with the target cell, the UE does not monitor the source cell.

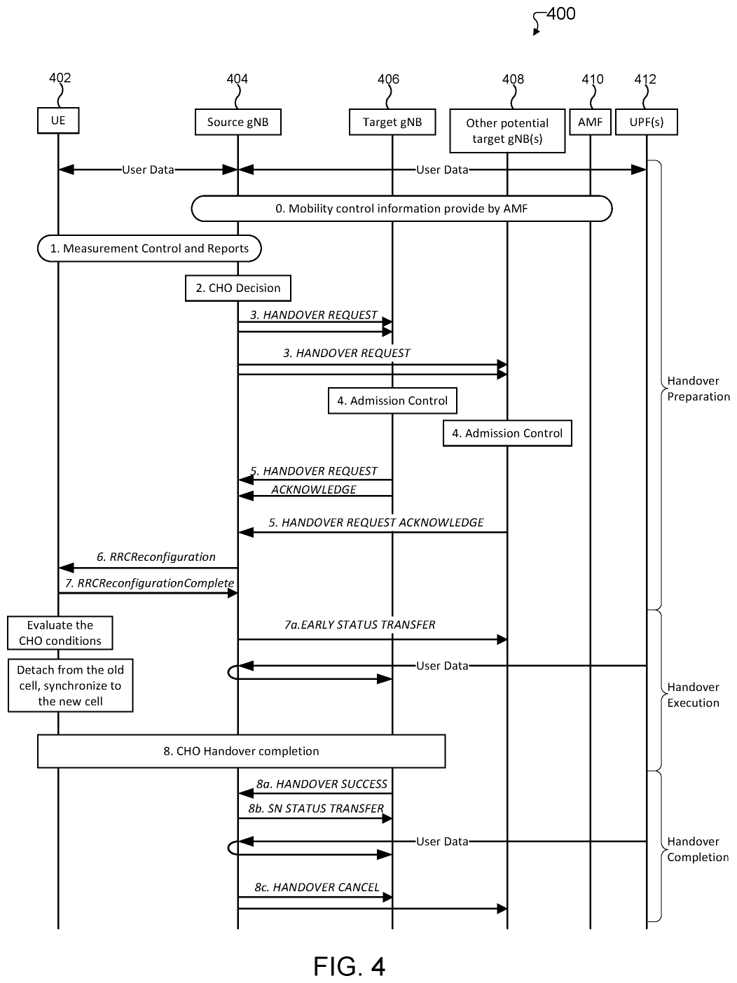

As in intra-NR RAN handover, in intra-NR RAN CHO, the preparation and execution phase of the conditional handover procedure is performed without involvement of the 5G core (5GC), i.e., preparation messages are directly exchanged between gNBs. The release of the resources at the source gNB during the conditional handover completion phase is triggered by the target gNB. The basic conditional handover scenario where neither the AMF nor the UPF changes is depicted in FIG. 4.

FIG. 4 illustrates an example conditional handover operation 400 according to embodiments of the present disclosure. An embodiment of the operation illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for a conditional handover operation could be used without departing from the scope of this disclosure.

The example of FIG. 4 begins at step 0. At step 0, UE context within the source gNB 404 contains information regarding roaming and access restrictions which were provided either at connection establishment or at the last tracking area update. At step 1, source gNB 404 configures UE measurement procedures and the UE 402 reports according to the measurement configuration. At step 2, source gNB 404 decides to use CHO.

At step 3, Source gNB requests CHO for one or more candidate cells belonging to one or more candidate gNBs 406 and 408. A CHO request message is sent for each candidate cell. At step 4, Admission Control may be performed by the target gNB(s) 406 and 408. Slice-aware admission control shall be performed if the slice information is sent to the target gNB(s). If the PDU sessions are associated with non-supported slices the target gNB(s) shall reject such PDU Sessions. At step 5, candidate gNB(s) 406 and 408 send a CHO response (HO REQUEST ACKNOWLEDGE) including configuration of CHO candidate cell(s) to source gNB 404. The CHO response message is sent for each candidate cell.

At step 6, source gNB 404 sends an RRCReconfiguration message to UE 402, containing the configuration of CHO candidate cell(s) and CHO execution condition(s). The CHO configuration of the candidate cells can be followed by other reconfiguration from source gNB 404. A configuration of a CHO candidate cell cannot contain a DAPS handover configuration. At step 7, UE 402 an RRC ReconfigurationComplete message to source gNB 404. At step 7a, if early data forwarding is applied, source gNB 404 sends the EARLY STATUS TRANSFER message.

At step 8, UE 402 maintains connection with source gNB 404 after receiving CHO configuration and starts evaluating the CHO execution conditions for the candidate cell(s). If at least one CHO candidate cell satisfies the corresponding CHO execution condition, the UE detaches from source gNB 404, applies the stored corresponding configuration for that selected candidate cell, synchronises to that candidate cell and completes the RRC handover procedure by sending an RRC ReconfigurationComplete message to the target gNB (e.g., Target gNB 406). The UE releases stored CHO configurations after successful completion of RRC handover procedure.

At step 8a, the target gNB (e.g., Target gNB 406) sends the HANDOVER SUCCESS message to source gNB 404 to inform that UE 402 has successfully accessed the target cell. In return, at step 8b, source gNB 404 sends the SN STATUS TRANSFER message. Late data forwarding may be initiated as soon as the source gNB receives the HANDOVER SUCCESS message. At step 8c, source gNB 404 sends the HANDOVER CANCEL message toward the other signalling connections or other candidate target gNBs, if any, to cancel CHO for the UE.

Although FIG. 4 illustrates one example conditional handover operation 400, various changes may be made to FIG. 4. For example, while shown as a series of steps, various steps in FIG. 4 could overlap, occur in parallel, occur in a different order, occur any number of times, be omitted, or replaced by other steps.

For mobility in connected mode, the handover in convention (e.g., CHO) is initiated by the network via higher layer signaling (e.g., an RRC message), based on L3 (Layer 3) measurements. However, this procedure involves more latency, signaling overhead and interruption time that may become the key issue in some scenarios with frequent handover, e.g., a UE in high-speed vehicular and in FR2 deployment. Reduction in overhead and/or latency and interruption time in handover procedure is desirable, such as with L1/L2 (Layer 1/Layer 2) Triggered Mobility (LTM), by which handover can be triggered by L1/L2 signaling based on L1 measurement. More specifically, LTM refers to a mobility mechanism where a UE switches from the source cell to a target cell with beam switching, where the beam switching decision is based on L1 measurement on beams among configured candidate cells, and the cell switch can be triggered by L1/L2 signaling from the network (NW) or triggered by the fulfillment of pre-configured conditional event (e.g., in a conditional LTM (CLTM) procedure). This may be referred to as a cell switch condition.

For LTM triggered by L1/L2 signaling from the network, the network may request the UE to perform early Timing Advance (TA) acquisition of a candidate cell before a cell switch. The early TA acquisition can be triggered by a PDCCH order or through UE-based TA measurement. The network indicates in the cell switch command whether the UE shall access the target cell with a random access (RA) based cell switch procedure if a TA value is not provided or with PUSCH transmission using the indicated TA value. Otherwise, the UE shall access the target cell with an RA free cell switch procedure.

When performing a cell switch to a target cell in CHO operation, the UE acquires the TA of the target cell by performing an RA procedure, which introduces delay in cell switching. To reduce the delay, the TA can be acquired early by UE initiation before executing the cell switch.

The present disclosure specifies a procedure for UE initiated early TA acquisition for a non-serving cell. The operation of the UE initiated early TA acquisition for a non-serving cell can be applied to a CHO procedure, a CLTM procedure, or inter-cell multi-TRP operation.

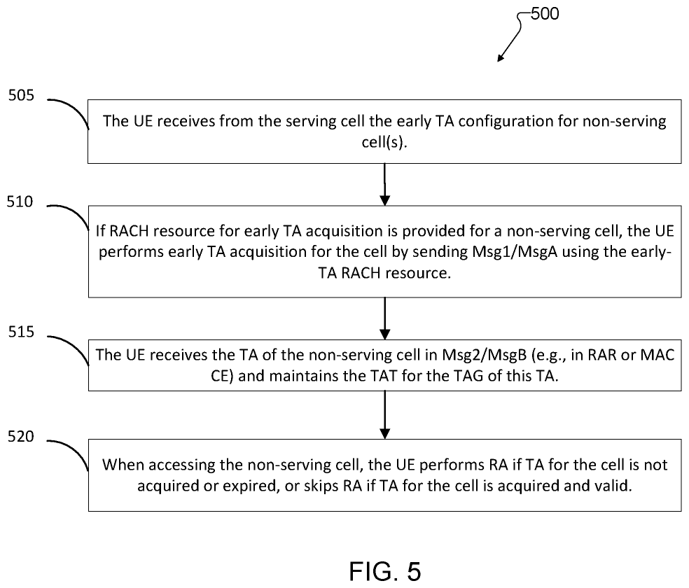

FIG. 5 illustrates an example UE procedure 500 of UE initiated early TA acquisition for a non-serving cell according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for a UE procedure of UE initiated early TA acquisition for a non-serving cell could be used without departing from the scope of this disclosure.

In the example of FIG. 5, procedure 500 begins at operation 505. At operation 505, a UE receives from the serving cell the early TA configuration for non-serving cell(s). Here, the non-serving cell can refer to a candidate cell with conditional reconfiguration provided for one or more operations of CHO, CLTM, conditional primary secondary cell group (SCG) cell (PSCell) addition and change (CPAC), CHO with candidate secondary cell groups (SCGs), or a non-serving cell (e.g., an additional cell) in inter-cell multi-TRP operation. The configuration for the non-serving cell can be provided, and stored by the UE. At operation 510, if a RACH resource for early TA acquisition is provided for a non-serving cell, the UE determines to perform early TA acquisition for the cell and sends a Msg1/MsgA in a contention-free random access (CFRA) procedure using the early-TA RACH resource. For example, the UE performs early TA acquisition for a CLTM candidate cell if for the candidate cell a RACH resource is available, TA is not acquired or not valid. In another example, the UE performs early TA acquisition for a CLTM candidate cell if for the candidate cell a RACH resource is available, TA is not acquired or not valid, and a CLTM execution condition is fulfilled. At operation 515, the UE receives the TA of the non-serving cell in a in a RAR or in a MAC CE and maintains the timing alignment timer (TAT) for the timing advance group (TAG) of this TA. At operation 520, when accessing the non-serving cell, the UE performs RA if the TA for the cell is not acquired or expired, or skips RA if the TA for the cell is acquired and valid. Here, accessing the non-serving cell can refer to cell switching to the cell due to mobility, for example, by CHO or CLTM procedure, or refer to any reception from and/or transmission to the non-serving cell by using resources associated to the non-serving cell, for example, by inter-cell multi-TRP operation.

In one embodiment, at operation 505, the early TA configuration for a non-serving cell can be provided by RRCReconfiguration message(s) from the serving cell. The early TA configuration can include the RA configuration and/or TAG configuration and/or a cell radio network temporary identifier (C-RNTI) associated to the non-serving cell. The RA configuration can include a RACH resource (e.g., for 4-step RA or 2-step RA), UL and/or DL configuration (e.g., for PDCCH, PDSCH, PUCCH, PUSCH) which can provide information including carrier, bandwidth part (BWP), search space, and control resource set, which are applied for the RA towards the non-serving cell. The non-serving cell may assign a different RACH configuration including a RACH resource to different serving cells. Based on the received PRACH preamble the non-serving cell can identify that serving cell.

In one example, a contention-free random access (CFRA) RACH resource for early TA acquisition can be provided, which can include PRACH occasions, and/or a number of SSBs per PRACH occasion, and/or SSB indexes, and/or CSI-RS indexes, and/or RA Preamble indexes, and/or PRACH occasion mask indexes, and/or a PRACH occasion list, such that the RACH resource is dedicated for a UE's early TA acquisition for a non-serving cell. A validity duration can be configured for the CFRA RACH resource for a candidate cell, indicating for how long the UE can consider the CFRA RACH resource is valid and can be used for early TA acquisition for a candidate cell. In another example, a cell-specific RACH resource that is common to UEs can be provided for contention-based random access (CBRA) for early TA acquisition. The TAG configuration for a candidate cell can include a TAG indicator (TAG ID) and/or a timeAlignmentTimer parameter to indicate the duration of the time alignment timer.

For the RACH configuration intended for the non-serving cell, one or more of the following parameters can be configured:
prach-ConfigurationIndex: the available set of PRACH occasions for the transmission of the Random-Access Preamble for Msg1. These are also applicable to the MSGA PRACH if the PRACH occasions are shared between 2-step and 4-step RA types;
msgA-PRACH-ConfigurationIndex: the available set of PRACH occasions for the transmission of the Random-Access Preamble for MSGA in 2-step RA type;
preamble ReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type;
rsrp-ThresholdCSI-RS: an RSRP threshold for the selection of CSI-RS for 4-step RA type;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
msgA-CFRA-PUSCH: PUSCH resource configuration(s) for msgA CFRA;
msgA-TransMax: The maximum number of MSGA transmissions when both 4-step and 2-step RA type Random Access Resources are configured;
powerRampingStep: the power-ramping factor;
msgA-PreamblePowerRampingStep: the power ramping factor for MSGA preamble;
powerRampingStepHighPriority: the power-ramping factor in case of prioritized Random-Access procedure;
scalingFactorBI: a scaling factor for prioritized Random-Access procedure;
ra-PreambleIndex: Random Access Preamble;
ra-ssb-OccasionMaskIndex: defines PRACH occasion(s) associated with an SSB in which the MAC entity may transmit a Random-Access Preamble;
msgA-SSB-SharedRO-MaskIndex: indicates the subset of 4-step RA type PRACH occasions shared with 2-step RA type PRACH occasions for each SSB.
ra-OccasionList: defines PRACH occasion(s) associated with a CSI-RS in which the MAC entity may transmit a Random-Access Preamble;
preamble TransMax: the maximum number of Random-Access Preamble transmission;
ssb-perRACH-OccasionAndCB-PreamblesPerSSB: defines the number of SSBs mapped to each PRACH occasion for 4-step RA type and the number of contention-based Random-Access Preambles mapped to each SSB;
msgA-CB-PreamblesPerSSB-PerSharedRO: defines the number of contention-based Random-Access Preambles for 2-step RA type mapped to each SSB when the PRACH occasions are shared between 2-step and 4-step RA types;
msgA-SSB-PerRACH-OccasionAndCB-PreamblesPerSSB: defines the number of SSBs mapped to each PRACH occasion for 2-step RA type and the number of contention-based Random-Access Preambles mapped to each SSB;
msgA-PUSCH-ResourceGroupA: defines MSGA PUSCH resources that the UE shall use when performing MSGA transmission using Random Access Preambles group A;
msgA-PUSCH-ResourceGroupB: defines MSGA PUSCH resources that the UE shall use when performing MSGA transmission using Random Access Preambles group B;
msgA-PUSCH-Resource-Index identifies the index of the PUSCH resource used for MSGA in case of contention-free Random Access with 2-step RA type;

If groupBconfigured is configured, then Random Access Preambles group B is configured for 4-step RA type. Amongst the contention-based Random-Access Preambles associated with an SSB, the first memberOfRA-PreamblesGroupA included in groupBconfigured Random Access Preambles belong to Random Access Preambles group A. The remaining Random-Access Preambles associated with the SSB belong to Random Access Preambles group B (if configured).

If groupB-ConfiguredTwoStepRA is configured, then Random Access Preambles group B is configured for 2-step RA type. Amongst the contention-based Random-Access Preambles for 2-step RA type associated with an SSB, the first memberOfRA-PreamblesGroupA included in GroupB-ConfiguredTwoStepRA Random Access Preambles belong to Random Access Preambles group A. The remaining Random-Access Preambles associated with the SSB belong to Random Access Preambles group B (if configured).

If Random Access Preambles group B is configured for 4-step RA type:
ra-Msg3SizeGroupA: the threshold to determine the groups of Random-Access Preambles for 4-step RA type;
msg3-DeltaPreamble: Δ_{PREAMBLE_Msg3};
messagePowerOffsetGroupB: the power offset for preamble selection included in groupBconfigured;
memberOfRA-PreamblesGroupA: defines the number of Random-Access Preambles in Random Access Preamble group A for each SSB included in groupBconfigured.

If Random Access Preambles group B is configured for 2-step RA type:
msgA-DeltaPreamble: Δ_{MsgA_PUSCH};
messagePowerOffsetGroupB: the power offset for preamble selection included in GroupB-ConfiguredTwoStepRA;
memberOfRA-PreamblesGroupA: defines the number of Random-Access Preambles in Random Access Preamble group A for each SSB included in GroupB-ConfiguredTwoStepRA;
ra-MsgA-SizeGroupA: the threshold to determine the groups of Random-Access Preambles for 2-step RA type.

The set of Random-Access Preambles and/or PRACH occasions for early TA acquisition, if any;
ra-ResponseWindow: the time window to monitor RA response(s) (SpCell only); the network may configure a value larger than or equal to 10 ms when Msg2 is transmitted in licensed spectrum for early TA acquisition;
ra-ContentionResolutionTimer: the Contention Resolution Timer (SpCell only); and
msgB-Response Window: the time window to monitor RA response(s) for 2-step RA type (SpCell only).

In one embodiment, at operation 505, the UE maintains a variable, denoted Var-1, to store the early TA configuration. For each entry received in a list of non-servings (e.g., candidate cells), if Var-1 includes an entry with the given ID of the non-serving, and if the entry includes an early TA configuration, the UE replaces the existing early TA configuration within Var-1 with the received early TA configuration for this ID. If Var-1 does not include an entry with the given ID of the non-serving, the UE adds a new entry for this ID within Var-1 and stores the received early TA configuration for this ID.

In one embodiment, at operation 510, if a validity duration is configured for the CFRA RACH resource for a non-serving cell in the early TA configuration, the UE starts a validity timer upon receiving the early TA configuration for the cell and sets the timer duration as the indicated validity duration. When the validity timer associated to a non-serving cell is running, the UE considers the CFRA RACH resource for this candidate cell is valid and can be used to send a PRACH to the candidate cell for early TA acquisition, either for initial acquisition of a TA for this cell or for a subsequent update of the TA for this cell. If the validity timer associated to a non-serving cell is expired, the UE releases the CFRA RACH resource for this cell and/or releases the early TA configuration associated to this cell.

In one embodiment, at operation 510, if an early TA configuration is provided for a candidate cell and a RACH resource for CFRA or CBRA (e.g., 4-step or 2-step RA) in the early TA configuration is included/configured/provided/available/valid, the UE sends a PRACH towards the candidate cell by initiating a RA procedure using the CFRA or CBRA RACH resource to acquire the TA of the candidate cell.

If firstActiveDownlinkBWP-Id and/or firstActiveUplinkBWP-Id is configured in the early TA configuration for the non-serving cell, the DL BWP and/or UL BWP indicated by firstActiveDownlinkBWP-Id and/or firstActiveUplinkBWP-Id respectively is active for the RA procedure for early TA acquisition. Otherwise, if firstActiveDownlinkBWP-Id and/or firstActiveUplinkBWP-Id is NOT configured in the early TA configuration for the non-serving cell, the initial downlink BWP and initial uplink BWP are used for the RA procedure for early TA acquisition.

If the CFRA resources for 4-step RA type have been explicitly provided in the early TA configuration for the BWP selected for early TA acquisition, the UE performs RA with 4-step RA type. If the CFRA resources for 2-step RA type have been explicitly provided in early TA configuration for the BWP selected for early TA acquisition, the UE performs RA with 2-step RA type. If the RA type is 4-step RA, the UE transmits a PRACH Preamble in Msg1 to the non-serving cell. If the RA type is 2-step RA, the UE transmits a PRACH Preamble and PUSCH in a MsgA to the non-serving cell, where a C-RNTI MAC CE can be included in the MsgA PUSCH. In one example, a C-RNTI associated to the non-serving cell can be assigned to the UE which is provided in the early TA configuration or in the configuration (e.g., RRCReconfiguration) for the non-serving cell (e.g., at operation 505), and the UE can include the C-RNTI of the non-serving cell in the C-RNTI MAC CE in the MsgA PUSCH. In another example, the UE can include the C-RNTI associated to the serving cell in the C-RNTI MAC CE in the MsgA PUSCH.

For PRACH Preamble transmission in Msg1/MsgA, if SSBs and/or Preamble index(es) have been explicitly provided in the CFRA resource in the early TA configuration for the non-serving cell, among them, the UE selects a SSB and sets a Preamble index corresponding to the selected SSB. If the CSI-RSs and/or Preamble index(es) have been explicitly provided in the CFRA resource in the early TA configuration for the non-serving cell, among them, the UE selects a CSI-RS and sets a Preamble index corresponding to the selected SSB. The UE determines the next available PRACH occasion from the PRACH occasions corresponding to the selected SSB permitted by the restrictions given by the configuration. The UE transmits the Msg1 using the selected PRACH occasion and the computed RA-RNTI.

For MsgA PUSCH transmission, the UE selects a PUSCH occasion from the PUSCH occasions configured in msgA-CFRA-PUSCH corresponding to the PRACH slot of the selected PRACH occasion, according to msgA-PUSCH-Resource-Index corresponding to the selected SSB. The UE determines the UL grant and the associated HARQ information for the MsgA payload in the selected PUSCH occasion. The UE delivers the UL grant and the associated HARQ information to the HARQ entity. The UE transmits the MsgA using the selected PRACH occasion and the associated PUSCH resource of the MsgA and the computed RA-RNTI, MsgB-RNTI.

In one embodiment, at operation 515, after sending the Msg1/MsgA for early TA acquisition to the candidate cell, the UE performs the procedure for Msg2/MsgB reception from the serving cell, where the non-serving cell can send to the serving cell the TA and RA-RNTI for the received PRACH Preamble so that the serving cell can inform UE the TA of the non-serving cell. Alternatively, after sending the Msg1/MsgA for early TA acquisition to the candidate cell, The UE performs the procedure for Msg2/MsgB reception from the non-serving cell if the UL and/or DL configuration for the non-serving cell is configured.

If a Msg1 in a 4-step CFRA is sent, the UE monitors the PDCCH of the serving cell or the PDCCH of the non-serving cell if configured for RAR identified by the RA-RNTI while the ra-ResponseWindow is running. If a valid downlink assignment has been received on the PDCCH for the RA-RNTI and the received transport block (TB) is successfully decoded, if the RAR contains a MAC subPDU with Random Access Preamble identifier (RAPID) corresponding to the transmitted Preamble index, the UE considers this RAR reception successful. If a CFRA is performed for early TA acquisition and RAR reception is successful, the UE considers the RA procedure successfully completed.

If a MsgA in a 2-step CFRA is sent, the UE monitors the PDCCH of the serving cell or the PDCCH of the non-serving cell if configured for a RAR identified by MSGB-RNTI while the msgB-Response Window is running. If C-RNTI MAC CE was included in the MsgA, the UE also monitors the PDCCH of the serving cell or the PDCCH of the non-serving cell if configured for RAR identified by the C-RNTI while the msgB-ResponseWindow is running.

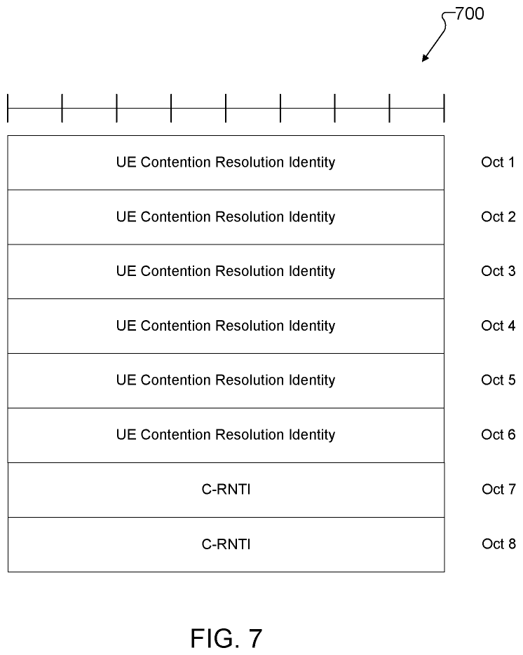

In one case, if notification of a reception of a PDCCH transmission of the serving cell or the PDCCH of the non-serving cell if configured is received from lower layers, and if the C-RNTI MAC CE was included in the MsgA, if a downlink assignment has been received on the PDCCH for the C-RNTI and the received TB is successfully decoded, and if the MAC PDU contains a MAC CE (e.g., an Absolute Timing Advance Command (TAC) MAC CE or a TAC MAC CE or a new MAC CE for early TA acquisition), the UE processes the received TAC, considers this RAR reception successful, stops the msgB-ResponseWindow, and considers this RA procedure successfully completed for early TA acquisition. As an example, a new MAC CE for early TA acquisition identified by a logical channel identifier (LCID) or extended LCID (eLCID) is provided in the present disclosure (illustrated in FIG. 7). The MAC CE can include the absolute TA of a non-serving cell, and/or the ID of the non-serving cell identifying the cell for which the TA included in the MAC CE is applied, and/or the TAG ID of the non-serving cell.

In another case, if notification of a reception of a PDCCH transmission of the serving cell or the PDCCH of the non-serving cell if configured is received from lower layers, and if the C-RNTI MAC CE was not included in the MsgA, if a valid downlink assignment has been received on the PDCCH for the MSGB-RNTI and the received TB is successfully decoded, and if the MsgB contains a fallbackRAR MAC subPDU, and if the RAPID in the MAC subPDU matches the transmitted Preamble index, the UE considers this RAR reception successful. If CFRA is performed for early TA acquisition and RAR reception is successful, the UE considers the RA procedure successfully completed.

In the RAR (e.g., MAC RAR, fallback RAR) or the TAC MAC CE or the Absolute TAC MAC CE that is contained in the Msg2 or MsgB, the UE considers the TA of the non-serving cell in the TAC. In another example, if the RAR (e.g., MAC RAR, fallback RAR) or the TAC MAC CE or the Absolute TAC MAC CE includes the TAG ID that matches the configured TAG ID associated to the non-serving cell in the early TA configuration, the UE considers that the TAC is intended for the non-serving cell. If the TA of the non-serving cell is acquired, the UE applies the TA for the non-serving and other cells, if any, belonging to the TAG configured in the early TA configuration associated to the candidate cell. The UE starts or restarts the time alignment timer for this TAG, and sets the timer duration as the value indicated by the parameter timerAlignmentTimer for the non-serving cell in the early TA configuration.

The UE may ignore the UL grant and/or Temporary C-RNTI included in the RAR (e.g., MAC RAR, fallback RAR) that is contained in Msg2 or MsgB. For instance, if the RA procedure for a non-serving cell is performed on an uplink carrier where PUSCH is not configured, the UE can ignore the received UL grant. Otherwise, the UE processes the received UL grant value and indicates it to the lower layers. Alternatively, the UE processes the received UL grant value in the RAR and indicates it to the lower layers for the initial PUSCH transmission to the non-serving cell after the early TA acquisition.

In another embodiment, at operation 510, if the CFRA is initiated by the UE for early TA acquisition for a CLTM candidate cell, the UE considers the RA procedure is successfully completed after transmitting the RA Preamble. At operation 515, the UE receives the TA of the candidate cell in a MAC CE (e.g., an Absolute Timing Advance Command MAC CE or a TAC MAC CE or a MAC CE for early TA acquisition) from the current serving cell.

The UE can perform operation 510 and 515 either to initially acquire a TA for a non-serving cell or to subsequently update the TA for a non-serving cell if the time alignment timer for the non-serving cell is expired (i.e., the previous TA is not valid). The MAC entity can indicate the early TA acquisition for a non-serving to upper layer whenever a TA for the non-serving cell is acquired or updated. The MAC entity can indicate the early TA expired for a non-serving cell whenever the associated time alignment timer is expired.

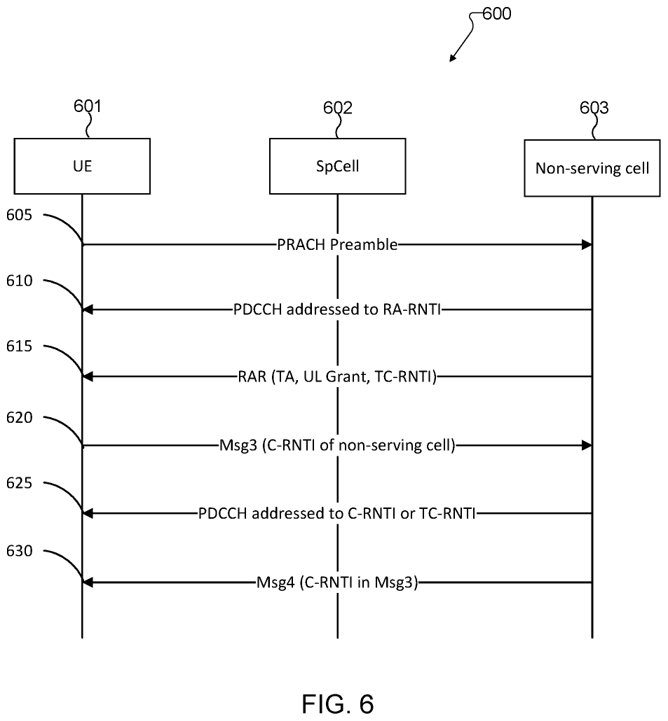

As an alternative to operations 510 and 515, The UE can perform contention-based RA (CBRA) using the configured cell-common RACH resource in the early TA configuration to acquire the TA of a non-serving cell if a CFRA resource is not explicitly provided and a cell-common RACH resource is available. An example embodiment is illustrated in FIG. 6.

Although FIG. 5 illustrates one example UE procedure 500 of UE initiated early TA acquisition for a non-serving cell, various changes may be made to FIG. 5. For example, while shown as a series of steps, various steps in FIG. 5 could overlap, occur in parallel, occur in a different order, occur any number of times, be omitted, or replaced by other steps.

FIG. 6 illustrates an example UE procedure 600 to perform 4-step CBRA for early TA acquisition without serving cell involvement according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for a UE procedure to perform 4-step CBRA for early TA acquisition without serving cell involvement could be used without departing from the scope of this disclosure.

In the example of FIG. 6, if the CBRA resources for 4-step RA type have been explicitly provided in an early TA configuration for the BWP selected for early TA acquisition, the UE 601 performs RA with 4-step RA type.

In the Example of FIG. 6, procedure 600 begins at operation 605. At operation 605, UE 601 performs RA with a 4-step RA type. UE 601 transmits a PRACH Preamble using the CBRA RACH resource included in the early TA configuration. UE 601 selects a SSB, and/or PRACH Preamble group if configured, and/or PRACH Preamble index, and/or PRACH occasion according to CBRA procedure.

At operation 610, UE 601 monitors the PDCCH of the non-serving cell for a RAR identified by the RA-RNTI while the ra-Response Window is running, where the PDCCH of non-serving cell 603 can be configured in the early TA configuration. If a valid downlink assignment has been received on the PDCCH for the RA-RNTI and the received TB is successfully decoded, if the RAR contains a MAC subPDU with RAPID corresponding to the transmitted Preamble index, UE considers this RAR reception successful.

At operation 615, if RAR reception is successful, UE 601 processes the TA, UL grant, and TC-RNTI included in the MAC RAR. UE 601 stores the TA. UE 601 processes the received UL grant in the RAR and indicate it to the lower layers for Msg3 transmission. UE 601 sets the TEMPORARY_C-RNTI to the value of TC-RNTI received in the RAR.

At operation 620, UE 601 sends a Msg3 to the non-serving cell 603 using the UL grant with a C-RNTI MAC CE included in the PUSCH, where the C-RNTI is of the non-serving cell 603. The C-RNTI associated to the non-serving cell 603 can be assigned to UE 601 which is provided in the early TA configuration or in the configuration (e.g., RRCReconfiguration) for the non-serving cell 603 (e.g., at operation 505 of FIG. 5).

At operation 625, once the Msg3 to the non-serving cell 603 is transmitted, UE 601 monitors the PDCCH of the non-serving cell 603 while the ra-ResponseWindow is running regardless of the possible occurrence of a measurement gap, where the PDCCH of non-serving cell 603 can be configured in the early TA configuration.

At operation 625, in one example, if the CBRA is initiated for early TA acquisition and C-RNTI of the non-serving cell is included in Msg3, and if the PDCCH received at operation 625 is addressed to the C-RNTI, UE 601 considers this Contention Resolution successful, stops ra-ContentionResolutionTimer, discards the TEMPORARY_C-RNTI, and considers this CBRA procedure for early TA acquisition is successfully completed.

At operation 625, in one more example, if a common control channel (CCCH) service data unit (SDU) was included in the Msg3 and the PDCCH received at operation 625 is addressed to its TEMPORARY C-RNTI, and if the MAC PDU is successfully decoded, the UE stops ra-ContentionResolutionTimer. At operation 630, if the MAC PDU contains an Early TA Contention Resolution Identity MAC CE (illustrated in FIG. 7), and if the UE Contention Resolution Identity in the MAC CE matches the CCCH SDU transmitted in the Msg3 and the C-RNTI in the MAC CE matches the C-RNTI value transmitted in the Msg3, UE 601 considers this Contention Resolution successful, discards the TEMPORARY_C-RNTI, and considers this CBRA procedure for early TA acquisition is successfully completed. Alternatively, at operation 630, if the MAC PDU contains a UE Contention Resolution Identity MAC CE and the UE Contention Resolution Identity in the MAC CE matches the CCCH SDU transmitted in the Msg3, and if the MAC PDU also contains a C-RNTI MAC CE that matches the C-RNTI value transmitted in the Msg3, UE 601 considers this Contention Resolution successful, discards the TEMPORARY_C-RNTI, and considers this CBRA procedure for early TA acquisition is successfully completed. One example of an Early TA Contention Resolution Identity MAC CE is illustrated in FIG. 7.

FIG. 7 illustrates an example Early TA Contention Resolution Identity MAC CE 700 according to embodiments of the present disclosure. The embodiment of an Early TA Contention Resolution Identity MAC CE of FIG. 7 is for illustration only. Different embodiments of an Early TA Contention Resolution Identity MAC CE could be used without departing from the scope of this disclosure.

In the Example of FIG. 7, the Early TA Contention Resolution Identity MAC CE is identified by a MAC subheader with LCID or eLCID. The MAC CE of FIG. 7 has a fixed 64-bit size and comprises fields defined as follows:
UE Contention Resolution Identity: This field contains the UL CCCH SDU. If the UL CCCH SDU is longer than 48 bits, this field contains the first 48 bits of the UL CCCH SDU.
C-RNTI: This field contains the C-RNTI of the MAC entity. The length of the field is 16 bits.

Although FIG. 7 illustrates an example Early TA Contention Resolution Identity MAC CE 700, various changes may be made to FIG. 7. For example, various changes to the UE Contention Resolution Identity field, the C-RNTI field, etc. could be made according to particular needs.

If CBRA is successfully completed, UE 601 considers the TA in the RAR is intended for the non-serving cell 603. In another example, if the RAR includes the TAG ID that matches the configured TAG ID associated to the non-serving cell in the early TA configuration, UE 601 considers that the TA is intended for the non-serving cell 603. If the TA of the non-serving cell is acquired, UE 601 applies the TA for the non-serving (i.e., non-serving cell 603) and other cells (e.g., SpCell 602), if any, belonging to the TAG configured in the early TA configuration associated to the candidate cell (i.e., non-serving cell 603). UE 601 starts or restarts the time alignment timer for this TAG, and sets the timer duration as the value indicated by the parameter timerAlignmentTimer for the non-serving cell in the early TA configuration. If ra-ContentionResolutionTimer expires, UE 601 discards the TEMPORARY_C-RNTI, considers the Contention Resolution not successful, and discards the TA in the RAR.

Although FIG. 6 illustrates one example UE procedure 600 to perform 4-step CBRA for early TA acquisition without serving cell involvement, various changes may be made to FIG. 6. For example, while shown as a series of steps, various steps in FIG. 6 could overlap, occur in parallel, occur in a different order, occur any number of times, be omitted, or replaced by other steps.

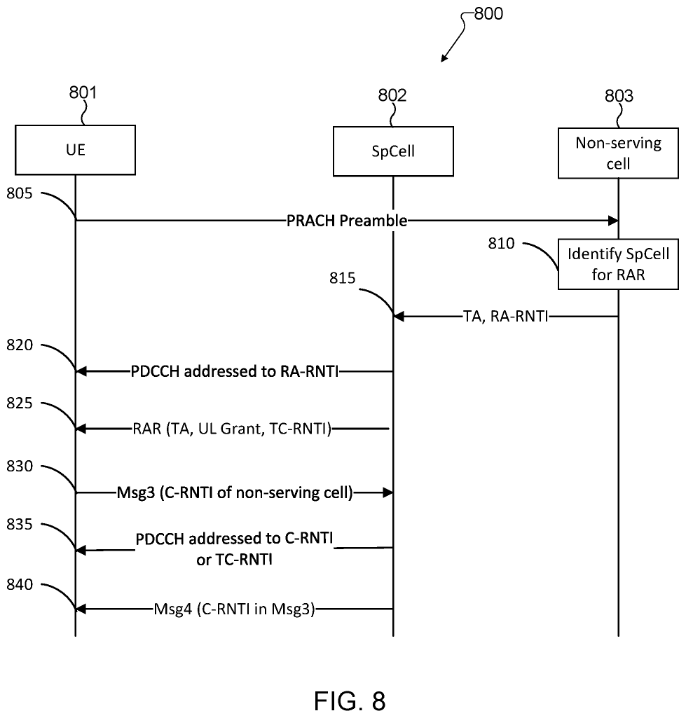

FIG. 8 illustrates an example UE procedure 800 to perform 4-step CBRA for early TA acquisition with serving cell involvement according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for a UE procedure to perform 4-step CBRA for early TA acquisition with serving cell involvement could be used without departing from the scope of this disclosure.

In the example of FIG. 8, if the CBRA resources for 4-step RA type have been explicitly provided in an early TA configuration for the BWP selected for early TA acquisition, the UE 801 performs RA with 4-step RA type.

In the example of FIG. 8, procedure 800 begins at operation 805. At operation 805, UE 801 transmits a PRACH Preamble using the CBRA RACH resource included in the early TA configuration. UE 804 selects a SSB, and/or PRACH Preamble group if configured, and/or PRACH Preamble index, and/or PRACH occasion according to CBRA procedure.

At operation 810, the non-serving cell 803 receives the PRACH Preamble sent using the CBRA resource for early TA acquisition assigned for the SpCell. The non-serving cell 803 may assign a different RACH configuration including a RACH resource to different serving cells. Based on the received PRACH preamble the non-serving cell 803 can identify that serving cell. At operation 815, the non-serving cell 803 sends to the serving cell (SpCell 802) the TA and RA-RNTI for the received PRACH Preamble.

At operation 820, UE 801 monitors the PDCCH of the serving cell 802 for a RAR identified by the RA-RNTI while the ra-ResponseWindow is running. If a valid downlink assignment has been received on the PDCCH for the RA-RNTI and the received TB is successfully decoded, if the RAR contains a MAC subPDU with RAPID corresponding to the transmitted Preamble index, UE 801 considers this RAR reception successful.

At operation 825, if the RAR reception is successful, UE 801 processes the TA, UL grant, and TC-RNTI included in the MAC RAR. UE 801 stores the TA. UE 801 processes the received UL grant in the RAR and indicates it to the lower layers for Msg3 transmission. UE 801 sets the TEMPORARY_C-RNTI to the value of TC-RNTI received in the RAR.

At operation 830, UE 801 sends a Msg3 to the serving cell 802 using the UL grant with a C-RNTI MAC CE included in the PUSCH, where the C-RNTI is of the non-serving cell 802. The C-RNTI associated to the non-serving cell 802 can be assigned to UE 801 which is provided in the early TA configuration or in the configuration (e.g., RRCReconfiguration) for the non-serving cell 802 (e.g., at operation 505 of FIG. 5).

At operation 835, once the Msg3 to the serving cell 802 is transmitted, UE 801 monitors the PDCCH of the serving cell while the ra-ResponseWindow is running regardless of the possible occurrence of a measurement gap.

At operation 840, in one example, if the CBRA is initiated for early TA acquisition and the C-RNTI of the non-serving cell is included in the Msg3, and if the PDCCH received at operation 835 is addressed to this C-RNTI, the UE 801 considers this Contention Resolution successful, stops ra-ContentionResolutionTimer, discards the TEMPORARY_C-RNTI, and considers this CBRA procedure for early TA acquisition is successfully completed.

In another example, at operation 840, if the CCCH SDU was included in the Msg3 and the PDCCH received at operation 835 is addressed to its TEMPORARY_C-RNTI, and if the MAC PDU is successfully decoded, UE 801 stops ra-ContentionResolutionTimer. At operation 840, if the MAC PDU contains an Early TA Contention Resolution Identity MAC CE (illustrated in FIG. 7), and if the UE Contention Resolution Identity in the MAC CE matches the CCCH SDU transmitted in the Msg3 and the C-RNTI in the MAC CE matches the C-RNTI value transmitted in the Msg3, UE 801 considers this Contention Resolution successful, discards the TEMPORARY_C-RNTI, and considers this CBRA procedure for early TA acquisition is successfully completed. Alternatively, at operation 840, if the MAC PDU contains a UE Contention Resolution Identity MAC CE and the UE Contention Resolution Identity in the MAC CE matches the CCCH SDU transmitted in the Msg3, and if the MAC PDU also contains a C-RNTI MAC CE that matches the C-RNTI value transmitted in the Msg3, UE 801 considers this Contention Resolution successful, discards the TEMPORARY_C-RNTI, and considers this CBRA procedure for early TA acquisition is successfully completed. One example of an Early TA Contention Resolution Identity MAC CE is illustrated in FIG. 7.

Although FIG. 8 illustrates one example UE procedure 800 to perform 4-step CBRA for early TA acquisition with serving cell involvement, various changes may be made to FIG. 8. For example, while shown as a series of steps, various steps in FIG. 8 could overlap, occur in parallel, occur in a different order, occur any number of times, be omitted, or replaced by other steps.

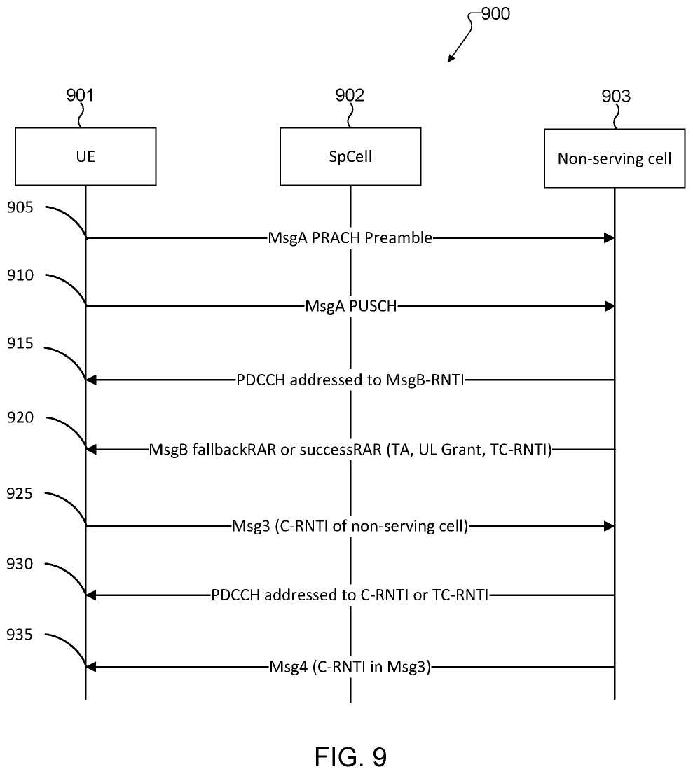

FIG. 9 illustrates an example UE procedure 900 to perform 2-step CBRA for early TA acquisition without serving cell involvement according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for a UE procedure to perform 2-step CBRA for early TA acquisition without serving cell involvement could be used without departing from the scope of this disclosure.

In the example of FIG. 9, if the CBRA resources for 2-step RA type have been explicitly provided in early TA configuration for the BWP selected for early TA acquisition, the UE 901 performs RA with 2-step RA type.

In the example of FIG. 9, procedure 900 begins at operation 905. At operation 905 and 910, UE 901 performs CBRA with 2-step RA type. UE 901 transmits a MsgA PRACH Preamble and a MsgA PUSCH using the CBRA RACH resource included in the early TA configuration. UE 901 selects a SSB, and/or PRACH Preamble group if configured, and/or PRACH Preamble index, and/or PRACH occasion and/or PUSCH occasion according to CBRA procedure.

At operation 915 and 920, if the MsgA in 2-step CBRA is sent, UE 901 monitors the PDCCH of the non-serving cell if configured for a RAR identified by MSGB-RNTI while the msgB-ResponseWindow is running.

In one case, if notification of a reception of a PDCCH transmission of the serving cell or the PDCCH of the non-serving cell if configured is received from lower layers, and if the C-RNTI MAC CE was not included in the MsgA, if a valid downlink assignment has been received on the PDCCH for the MSGB-RNTI and the received TB is successfully decoded, and if the MSGB contains a successRAR MAC subPDU, and if the CCCH SDU was included in the MSGA and the UE Contention Resolution Identity in the successRAR MAC subPDU matches the CCCH

SDU, and if the C-RNTI in the successRAR MAC subPDU matches the C-RNTI of the non-serving cell which is configured in early TA configuration or the configuration associated to the non-serving cell, UE 901 stops msgB-Response Window, considers this RAR reception successful, and considers the 2-step CBRA for early TA acquisition successful. UE 901 processes the TA in the successRAR. UE 901 considers the TA in the successRAR is intended for the non-serving cell 903. In another example, if the successRAR includes the TAG ID that matches the configured TAG ID associated to the non-serving cell 903 in the early TA configuration, UE 901 considers that the TA is intended for the non-serving cell 903. If the TA of the non-serving cell 903 is acquired, UE 901 applies the TA for the non-serving (i.e., non-serving cell 903) and other cells (e.g., SpCell 902), if any, belonging to the TAG configured in the early TA configuration associated to the candidate cell (i.e., non-serving cell 903). UE 901 starts or restarts the time alignment timer for this TAG, and sets the timer duration as the value indicated by the parameter timerAlignmentTimer for the non-serving cell 903 in the early TA configuration. If ra-ContentionResolutionTimer expires, UE 901 discards the TEMPORARY_C-RNTI, considers the Contention Resolution not successful, and discards the TA in the RAR. UE 901 may ignore the TPC, PUCCH resource Indicator, ChannelAccess-CPext (if indicated), and HARQ feedback Timing Indicator received in successRAR.

In another case, if notification of a reception of a PDCCH transmission of the serving cell or the PDCCH of the non-serving cell 903 if configured is received from lower layers, and if the C-RNTI MAC CE was not included in the MsgA, if a valid downlink assignment has been received on the PDCCH for the MSGB-RNTI and the received TB is successfully decoded, and if the MsgB contains a fallbackRAR MAC subPDU, and if the RAPID in the MAC subPDU matches the transmitted Preamble index, UE 901 considers this RAR reception successful. If the RAR reception is successful, UE 901 processes the TA, UL grant, and TC-RNTI included in the MAC RAR. UE 901 stores the TA. UE 901 processes the received UL grant in the RAR and indicates it to the lower layers for Msg3 transmission. UE 901 sets the TEMPORARY C-RNTI to the value of TC-RNTI received in the RAR. UE 901 performs the fallback 4-step CBRA at operation 925, 930, 935 according to the operations described with respect to operations 620, 625, 630, respectively of FIG. 6.

For another embodiment of 2-step CBRA, UE 901 can also perform operation 915-935 towards the serving cell with the same UE behavior, except that after MsgA transmission to the non-serving cell (i.e., SpCell 902), UE 901 monitors the PDCCH of the serving cell 902 for a RAR identified by MSGB-RNTI while the msgB-ResponseWindow is running, and receives successRAR or fallback RAR in MsgB from the serving cell 902, and if the fallback RAR is received, UE 901 performs the fallback 4-step CBRA at operation 925, 930, 935 according to the operations described with respect to operations 830, 835, 840, respectively of FIG. 8.

Although FIG. 9 illustrates one example UE procedure 900 to perform 2-step CBRA for early TA acquisition without serving cell involvement, various changes may be made to FIG. 9. For example, while shown as a series of steps, various steps in FIG. 9 could overlap, occur in parallel, occur in a different order, occur any number of times, be omitted, or replaced by other steps.

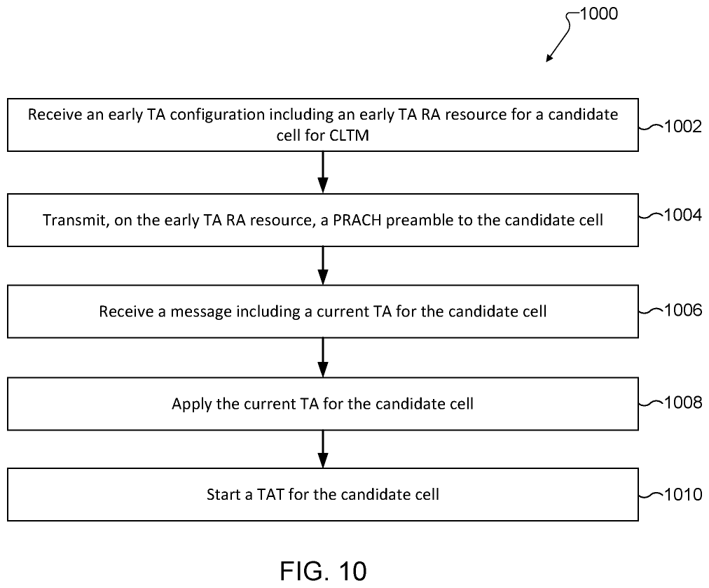

FIG. 10 illustrates an example method for UE initiated early timing advance acquisition 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for UE initiated early timing advance acquisition could be used without departing from the scope of this disclosure.

In the example of FIG. 10, method 1000 begins at step 1002. At step 1002, a UE such as UE 116 of FIG. 1 receives an early TA configuration including an early TA RA resource for a candidate cell for CLTM. At sept 1004, the UE transmits, on the early TA RA resource, a PRACH preamble to the candidate cell. At step 1006, the UE receives a message including a current TA for the candidate cell. A step 1008, the UE applies the current TA for the candidate cell. Finally, at step 1010, the UE starts a TAT for the candidate cell.

Although FIG. 10 illustrates one example method for UE initiated early timing advance acquisition 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive an early timing advance (TA) configuration including an early TA random access (RA) resource for a candidate cell for conditional layer 1/layer 2 triggered mobility (CLTM);
transmit, on the early TA RA resource, a physical random access channel (PRACH) preamble to the candidate cell; and
receive a message including a current TA for the candidate cell; and
a processor operatively coupled to the transceiver, the processor configured to:
apply the current TA to the candidate cell; and
start a time alignment timer (TAT) for the candidate cell.

2. The UE of claim 1, wherein:
the processor is further configured to:
determine whether the RA resource is available; and
determine that a previous TA for the candidate cell is not valid; and
the transceiver is further configured to transmit the PRACH preamble in response to the RA resource being available and the previous TA being not valid.

3. The UE of claim 2, wherein:
the processor is further configured to determine whether a cell switch condition for the candidate cell is fulfilled; and
the transceiver is further configured to transmit the PRACH preamble in response to the cell switch condition for the candidate cell being fulfilled.

4. The UE of claim 1, wherein the processor is further configured to:
determine whether the current TA of the candidate cell is valid;
if the current TA of the candidate cell is valid, initiate an RA free cell switch procedure with the candidate cell; and
if the current TA of the candidate cell is not valid, initiate an RA based cell switch procedure with the candidate cell.

5. The UE of claim 1, wherein the candidate cell is a candidate cell for one of:
conditional handover (CHO);
conditional primary secondary cell group (SCG) cell (PSCell) addition and change (CPAC); and
an additional cell in an inter-cell multi-TRP operation.

6. The UE of claim 1, wherein the early TA configuration includes at least one of:
a TA group (TAG) for the candidate cell;
a TAT for the candidate cell; and
a cell radio network temporary identifier (C-RNTI) for the candidate cell.

7. The UE of claim 1, wherein:
the message includes a MAC CE identified by a logical channel identifier (LCID) or an extended LCID (eLCID) for early TA acquisition; and
the MAC CE includes at least one of:
a field for the current TA of the candidate cell;
a field indicating a timing advance group indicator (TAG ID); and
a field indicating the candidate cell.

8. The UE of claim 1, wherein:
the PRACH preamble is a message 1 (Msg1) for a 4-step contention based RA (CBRA) procedure; and
the transceiver is further configured to:
receive a message 2 (Msg2) including the current TA for the candidate cell from a serving cell of the UE or from the candidate cell; and
transmit a message 3 (Msg3) to the serving cell of the UE or to the candidate cell; and
receive a message 4 (Msg4) from the serving cell of the UE or from the candidate cell.

9. A base station (BS) comprising:
a processor; and
a transceiver operatively coupled to the processor, the transceiver configured to:
transmit an early timing advance (TA) configuration including an early TA random access (RA) resource for a candidate cell for conditional layer 1/layer 2 triggered mobility (CLTM);
receive, on an early timing advance (TA) random access (RA) resource, a physical random access channel (PRACH) preamble for the candidate cell;
transmit a message including a current TA for the candidate cell.

10. The BS of claim 9, wherein the candidate cell is a candidate cell for one of:
conditional handover (CHO);
conditional primary secondary cell group (SCG) cell (PSCell) addition and change (CPAC); and
an additional cell in an inter-cell multi-TRP operation.

11. The BS of claim 9, wherein:
the message includes a MAC CE identified by a logical channel identifier (LCID) or an extended LCID (eLCID) for early TA acquisition; and
the MAC CE includes at least one of:
a field for the current TA of the candidate cell;
a field indicating a timing advance group indicator (TAG ID); and
a field indicating the candidate cell.

12. The BS of claim 9, wherein:
the PRACH preamble is a message 1 (Msg1) for a 4-step contention based RA (CBRA) procedure; and
the transceiver is further configured to:
transmit a message 2 (Msg2) including the current TA for the candidate cell;
receive a message 3 (Msg3); and
transmit a message 4 (Msg4).

13. A method of operating a user equipment (UE), the method comprising:
receiving an early timing advance (TA) configuration including an early TA random access (RA) resource for a candidate cell for conditional layer 1/layer 2 triggered mobility (CLTM);
transmitting, on the early TA RA resource, a physical random access channel (PRACH) preamble to the candidate cell;
receiving a message including a current TA for the candidate cell;
applying the current TA to the candidate cell; and
starting a time alignment timer (TAT) for the candidate cell.

14. The method of claim 13, further comprising:
determining whether the RA resource is available;
determining that a previous TA for the candidate cell is not valid; and
transmitting the PRACH preamble in response to the RA resource being available and the previous TA being not valid.

15. The method of claim 14, further comprising:
determining whether a cell switch condition for the candidate cell is fulfilled; and
transmitting the PRACH preamble in response to the cell switch condition for the candidate cell being fulfilled.

16. The method of claim 13, further comprising:
determining whether the current TA of the candidate cell is valid;
if the current TA of the candidate cell is valid, initiating an RA free cell switch procedure with the candidate cell; and
if the current TA of the candidate cell is not valid, initiating an RA based cell switch procedure with the candidate cell.

17. The method of claim 13, wherein the candidate cell is a candidate cell for one of:
conditional handover (CHO);
conditional primary secondary cell group (SCG) cell (PSCell) addition and change (CPAC); and
an additional cell in an inter-cell multi-TRP operation.

18. The method of claim 13, wherein the early TA configuration includes at least one of:
a TA group (TAG) for the candidate cell;
a TAT for the candidate cell; and
a cell radio network temporary identifier (C-RNTI) for the candidate cell.

19. The method of claim 13, wherein:
the message includes a MAC CE identified by a logical channel identifier (LCID) or an extended LCID (eLCID) for early TA acquisition; and
the MAC CE includes at least one of:
a field for the current TA of the candidate cell;
a field indicating a timing advance group indicator (TAG ID); and
a field indicating the candidate cell.

20. The method of claim 13, wherein:
the PRACH preamble is a message 1 (Msg1) for a 4-step contention based RA (CBRA) procedure; and
the method further comprises:
receiving a message 2 (Msg2) including the current TA for the candidate cell from a serving cell of the UE or from the candidate cell; and
transmitting a message 3 (Msg3) to the serving cell of the UE or to the candidate cell; and
receiving a message 4 (Msg4) from the serving cell of the UE or from the candidate cell.
